(19) United States
(12) Patent Application Publication
(10) Pub. No.: US 2023/0101928 A1
(43) Pub. Date: Mar. 30, 2023

(54) USER ATTRIBUTE PREFERENCE MODEL

(71) Applicant: Target Brands, Inc., Minneapolis, MN (US)

(72) Inventors: Amit Pande, Ames, IA (US); Rahul Biswas, Minneapolis, MN (US)

(21) Appl. No.: 17/484,932

(22) Filed: Sep. 24, 2021

(51) Int. Cl. G06Q 30/06; G06N 5/04

(52) U.S. Cl. CPC G06Q 30/0631; G06N 5/04

(57) ABSTRACT

The present disclosure provides methods and systems for providing recommendations of items to a user that are based on the user's preferences of attributes of those items. The system collects user session data and identifies attributes of items that the user may have interacted with in a previous shopping session and to assign user interest scores to the attributes based on the type user interaction with the item (e.g., selected, added to the user's shopping cart, or purchased). A decay factory may be applied to each user interest score to adjust the score over time. When a request is received for an item recommendation for the user, the system may determine user attribute preference (UAP) scores for a group of items based on the user interest scores and provide a UAP-based recommendation in a response based on the UAP scores.

### BACKGROUND

In today's technology driven world, most retailers have online platforms via which customers (herein referred to as users) can order items online, rather than or in connection with purchasing items in-store. One of many advantages of online shopping is that retailers may sometimes use a recommendation system that may operate to recommend items to a user that may be relevant to items for which the user may be shopping. Online retailers that implement recommendation techniques may be able to increase user satisfaction by reducing the amount of time a user may spend navigating the retailer's website to find items that may be of interest to the user and/or introducing the user to new items that may not be normally viewed by the user. Existing item recommendation systems that are implemented on retail websites may identify items to be recommended to users in a number of ways. For example, items may be identified and recommended to users based on popularity of the item (e.g., best-selling items), or based on the fact that the item was previously viewed by the customer. Still further, other systems may attempt to derive item selections for purposes of generating item recommendations based on similarities between the item being viewed and items to be recommended based on the item that is viewed. Still further, other systems may identify and recommend items to users based on items that are frequently purchased together.

Typically, recommendation performance is higher when recommendations are personalized to the user. In other words, when recommendations for products or services are displayed to a specific user based on input about the user's interests, the chances of the user clicking on and purchasing a recommended product or service are increased.

Moreover, recommendation performance may be further increased when recommendations are personalized to the user's preferences of attributes of items. That is, when recommendations for products or services are displayed to a specific user based on input about the user's preferences for attributes associated with the product or service type, the chances of the user clicking on and purchasing a recommended product or service are further increased.

### SUMMARY

In summary, the present disclosure relates to methods and systems for providing recommendations of items to a user that are based on the user's preferences of attributes of those items. Various aspects are described in this disclosure, which include, but are not limited to, the following aspects.

In one aspect, a system for providing item recommendations based on a user's attribute preferences comprises: at least one processor; and a memory coupled to the at least one processor, the memory including instructions that when executed by the at least one processor cause the system to: receive a request for an item recommendation for a user, the item recommendation corresponding to items available for purchase from a retail website; determine a set of items of interest to evaluate based on the request; identify attributes associated with each item of interest; map the one or more attributes to attribute preference information stored for the user, the attribute preference information including a first score corresponding to each attribute, the first score determined based on a type of an interaction and an amount of time since the interaction performed by the user in one or more online shopping sessions with one or more of the items available for purchase; determine a second score for each item of interest based on the attribute preference information; rank the items of interest based on the second scores; determine a UAP-based recommendation based on the ranked items of interest; and generate a response to the request including the UAP-based recommendation to be presented to the user in a user interface, the UAP-based recommendation including one or more items having attributes preferred by the user.

the first score determined based on a type of an interaction and an amount of time since the interaction performed by the user

In another aspect, a method for providing item recommendations based on a user's attribute preferences comprises receiving a request for an item recommendation for a user, the item recommendation corresponding to items available for purchase from a retail website; determining a set of items of interest to evaluate based on the request; identifying attributes associated with each item of interest; mapping the one or more attributes to attribute preference information stored for the user, the attribute preference information including a first score corresponding to each attribute, the first score determined based on a type of an interaction and an amount of time since the interaction performed by the user in one or more online shopping sessions with one or more of the items available for purchase; determining a second score for each item of interest based on the attribute preference information; ranking the items of interest based on the second scores; determining a user attribute preference (UAP)-based recommendation based on the ranked items of interest; and generating a response to the request including the UAP-based recommendation to be presented to the user in a user interface, the UAP-based recommendation including one or more items having attributes preferred by the user.

In another aspect, a computer readable storage medium including executable instructions which, when executed by a processor, cause the processor to provide item recommendations based on a user's attribute preferences, the instructions comprising: receiving a data record associated with an interaction performed by a user in association with an item available for purchase from a retail website; assigning a user interest score to the item based on a type of interaction performed by the user; applying a decay function to the user interest score to adjust the user interest score based on a number of days since the interaction; identifying attributes associated with the item; assigning the decayed user interest score to each of the attributes identified in association with the item; determining an aggregated attribute user interest score for each attribute by aggregating the decayed user interest score assigned to the attribute; and storing the aggregated attribute user interest scores.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram illustrating an example system that may be implemented for providing recommendations of items to a user that are based on the user's preferences of attributes of those items.

FIG. 2 is a block diagram illustrating an example embodiment of an example user attribute preference (UAP) recommendation system.

FIG. 3 is an illustration of a table including example user session data collected in association with user activities with various items in one or more online shopping sessions and user interest scored determined for each user activity.

FIG. 4 is an illustration of a table including attribute user interest scores determined for the various items included in the table in FIG. 3 and applied to each attribute included in the various items.

FIG. 5 is an illustration of a table including aggregated attribute user interest scores for each attribute included in the various items.

FIG. 6 is an illustration of a table including UAP scores and rankings determined for a plurality of items based on the aggregated attribute user interest scores.

FIG. 7 is an illustration of an example user interface in which recommendations of items determined based on the user's preferences of attributes of those items may be presented to the user.

FIG. 8 is an illustration of a table including results of a comparison between users' interactions with non-personalized recommendations, personalized recommendations, and UAP-based recommendations.

FIG. 9 is an illustration of a table including results of a comparison between conversion rates of selections of recommendations to purchases of the recommended items based on the recommendation type.

FIG. 10 is a flow chart depicting general stages of an example process or method for providing recommendations of items to a user that are based on the user's preferences of attributes of those items in an example implementation.

FIG. 11 is a flow chart depicting general stages of an example process or method for providing recommendations of items to a user that are based on the user's preferences of attributes of those items in another example implementation.

FIG. 12 is an illustration of an example computing system with which aspects of the present disclosure may be implemented.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

As briefly described above, the present disclosure describes providing recommendations of items to a user that are based on the user's preferences of attributes of those items. Previously available recommendation tools may recommend items based on item similarities, items that may be frequently purchased together, or as a substitute for another item, for example, generally across a population, rather than with regard to a specific user's preferences. Accordingly, previously available recommendation tools may not satisfy click-through rate goals, conversion (purchase) rate goals, or other performance metrics, that may otherwise be improved via utilizing user browsing and purchase activity data and item attributes data in order to determine attributes of preference to a user.

Aspects of the disclosed user attribute preference-based (UAP) recommendation system may be used by retail enterprises that offer a variety of products through online websites to improve click-through rate goals, conversion (purchase) rate goals, or other performance metrics. The disclosed UAP recommendation system utilizes user data and item attribute data in order to determine attributes of preference to a user. For example, attributes of items that the user may have interacted with in a previous shopping session may be identified, and user interest scores may be assigned to the attributes based on the user activity (e.g., viewed by the user, added to the user's shopping cart, or purchased by the user). The user interest scores on each item attribute may be stored and may be adjusted cyclically (e.g., daily) based on a decay factor to accommodate the way in which the user's interests or preferences may change over time.

Typically, the website of an online retailer selling various items may be organized to include a hierarchy of webpages. For example, an online retailer website may include item listing webpages that may list a plurality of items, often grouped together because of some similarity between the items, such as results from a search for an item, items with a same classification (e.g., category identifier (ID)), etc. When a new group of items are presented to the user in a webpage, the attributes of the new group items may be identified and mapped to the attributes of preference and the associated user interest scores determined for the user. The user interest scores for the attributes of preference of the new group items may be aggregated, at the item level, for generating recommendations for the user. In some examples, the recommendations may include a set of top ranked new group items, wherein the new group items may be ranked based on the aggregated user interest scores. For example, the items that may be recommended to the user may include various items within an item category that have attributes that are preferred by that specific user as determined by the user's previous browsing and purchasing activity. Determining a specific user's preferences of item attributes and using the user's attribute preferences to deliver a recommendation to the user can be effective in improving click-through rates, conversion (purchase) rates, and other performance metrics over at least a baseline recommendation of generally-popular items.

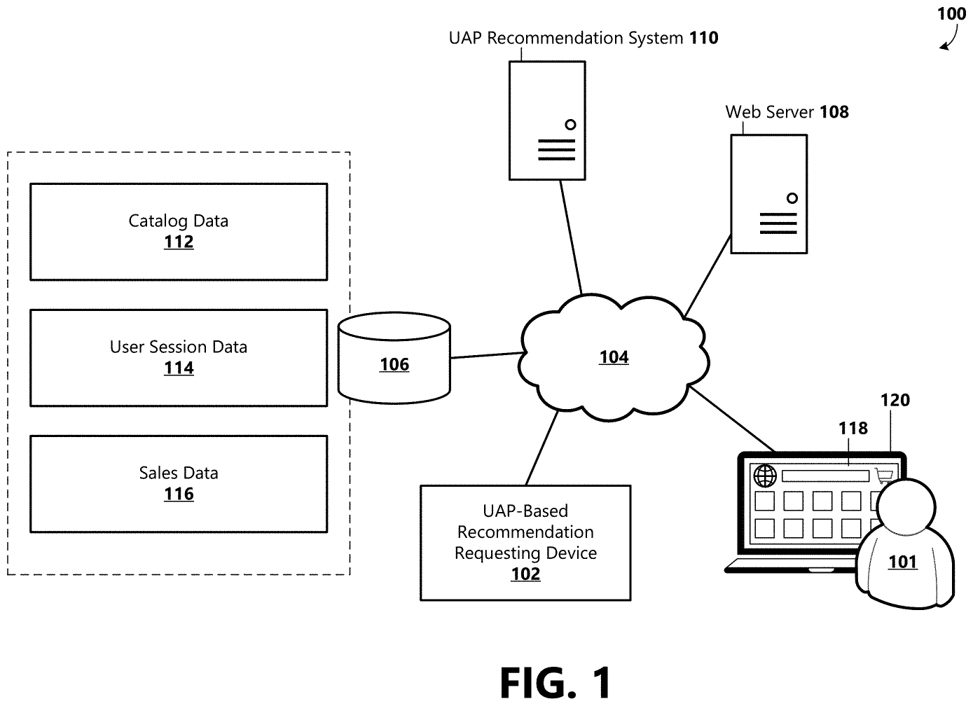

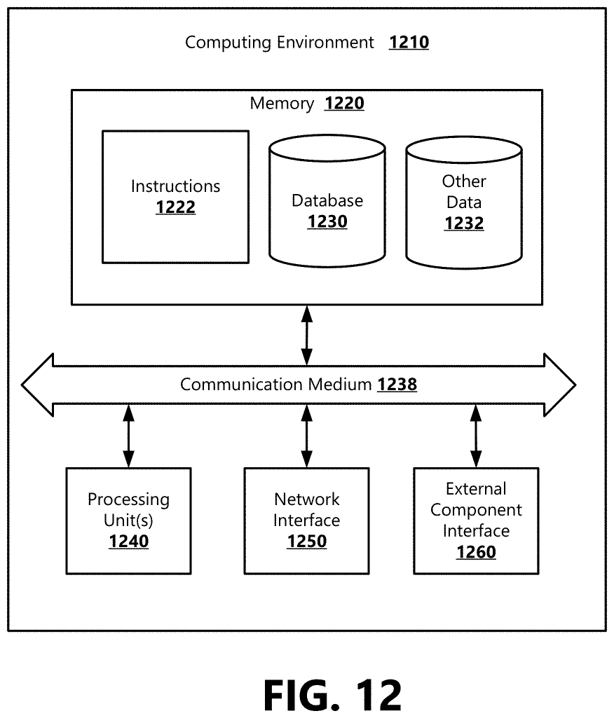

FIG. 1 is a block diagram illustrating an example system 100 that may be implemented for providing recommendations of items to a user 101 that are based on the user's preferences of attributes of those items. For example, the system 100 may include a user attribute preference-based (UAP) recommendation system 110, a web server 108, a datastore 106, a plurality of user computing devices 120a-n (generally, 120), and a UAP-based recommendation requesting device 102 communicatively connected over a network 104 or a combination of networks. Non-limiting examples of networks 104 can include the Internet, an intranet, an extranet, a local-area network, a wide-area network, an edge network, wired networks, wireless networks, and combinations thereof. The UAP recommendation system 110, the web server 108, the datastore 106, the plurality of user computing devices 120, the UAP-based recommendation requesting device 102, and other components in the system 100 may be implemented using various types of computing devices that include at least one processor and a memory coupled to the at least one processor, the memory including instructions that when executed by the at least one processor operate to perform one or more operations associated with recommending items to a user 101. Non-limiting examples of computing devices include servers, workstations, checkout POS units, desktop computers, laptop computers, mobile phones, tablets, smart devices, gaming devices, wearable devices, databases, etc. Further details of the computing devices and variations thereof can be found in FIG. 12.

In some examples, the UAP recommendation system 110 may be associated with an enterprise, such as a retail enterprise that offers goods and/or services, also referred to herein as items, to users. According to an aspect, the retail enterprise may include an online sales channel through which items are sold. Although examples are presented primarily regarding the retail industry, these are presented as non-limiting examples, as enterprises in other goods, services, healthcare, educational, professional, and other industries may also make use of the present disclosure.

In some examples, the web server 108 may operate to host the retail enterprise's website, which may be comprised of one or more webpages. In some examples, a plurality of user computing devices 120 may operate to communicate with the web server 108 over the network 104. For example, each of plurality of user computing devices 120 may be operative to view, access, and interact with webpages hosted by the web server 108. According to an example, a user 101 of one of the plurality of user computing devices 120 may access a webpage hosted by the web server 108, which may list one or more items that are available for purchase. The user computing device 120 may operate to display such items to the user in a user interface (UI) 118 via a web browser or another application or user agent. In some examples, the user 101 may click on or otherwise select an item, such as to view more information about the item. In some examples, the user 101 may further add one or more items presented in the webpage to an online shopping cart associated with the website and perform an online checkout of the shopping cart to purchase the items.

In some examples, the web server 108 and the UAP recommendation system 110 may operate to access a datastore 106 via the network 104. For example, the web server 108 and the UAP recommendation system 110 may be operative or configured to store data to and/or read data from the datastore 106. In some examples, the datastore 106 may be configured as a remote storage device, such as a cloud-based server, a memory device on another application server, a networked computer, or any other suitable remote storage. Although shown in FIG. 1 as remote to the web server 108 and the UAP recommendation system 110, in other examples, the datastore 106 may operate as a local storage device. Moreover, in some examples, the datastore 106 may include a plurality of datastores.

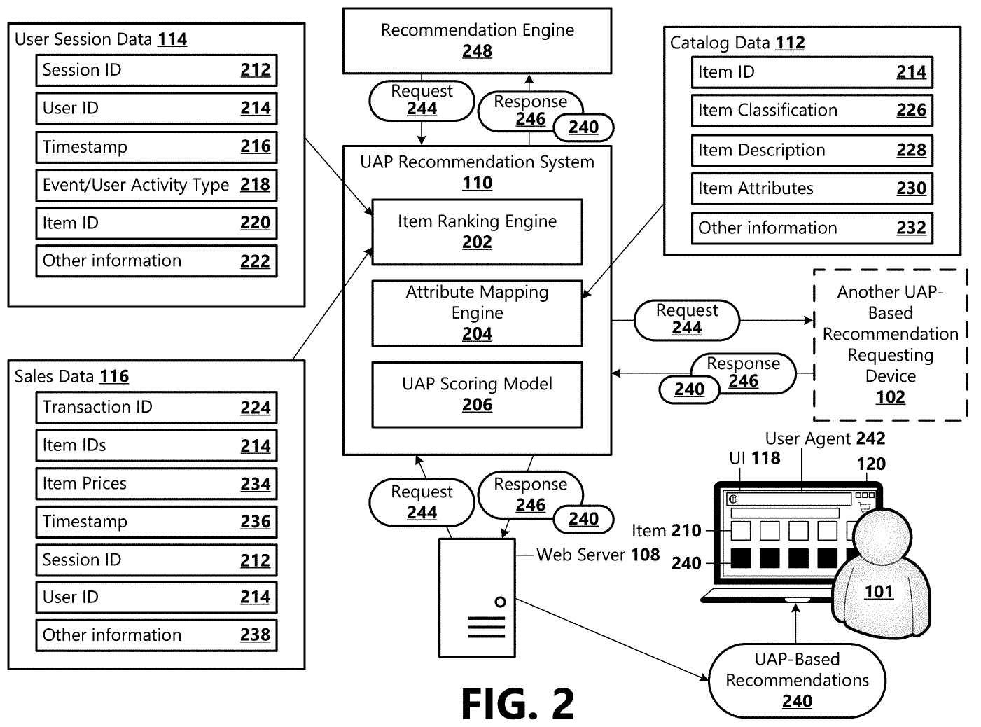

In some examples, the datastore 106 may store catalog data 112, which, in some examples, may include information about a portion or a comprehensive collection of the items offered by the retail enterprise. In some examples, the datastore 106 may further store user session data 114, which may include data for a specific user 101 for an online shopping session. According to one example implementation, user session data 114 may be collected about various online shopping session events. Example online shopping session events may include, but are not limited to, viewing (e.g., selecting or viewing) an item, adding an item to a shopping cart, and purchasing an item. As an example, when a user 101 views an item, which, in some examples, may include the user 101 clicking on or otherwise selecting the item, user session data 114 associated with the event (i.e., view activity) may be collected by the web server 108 and stored in the datastore 106. In some examples, the datastore 106 may further store sales data 116, which, in some examples, may include online purchase data received from the web server 108. In some example implementations, the sales data 116 may further include in-store purchase data that may be collected from one or more store locations. For example, sales data 116 may include data that may identify and describe a purchase from a retail enterprise. Example catalog data 112, user session data 114, and sales data 116 are described below with reference to FIG. 2.

The UAP recommendation system 110 may further operate to determine recommendations of items for a user 101. For example, the UAP-based recommendation requesting device 102 may be in communication with the UAP recommendation system 110 to request and receive user attribute preference-based recommendations for the user 101. According to one example, the UAP-based recommendation requesting device 102 may be the web server 108. According to another example, the UAP-based recommendation requesting device 102 may be a recommendation engine. According to another example, the UAP-based recommendation requesting device 102 may be another type of requesting device.

In some example implementations, the UAP recommendation system 110 may operate to receive a request for and provide a set of recommended items in a specified item category. In other example implementations, the UAP recommendation system 110 may operate to receive a request for and provide a set of top ranked item categories based on the user's attribute preferences. In other example implementations, the UAP recommendation system 110 may operate to receive a request for and provide a set of top ranked item brands based on the user's attribute preferences. In other example implementations, the UAP recommendation system 110 may operate to receive a request for and provide a set of items included in the set of top item categories and the set of top item brands. In other example implementations, the UAP recommendation system 110 may operate to receive a request for and provide a set of top ranked items based on the user's attribute preferences. For example, the set of top ranked items may be in a same item category or in different item categories. In other example implementations, the UAP recommendation system 110 may operate to receive a request for and provide user interest scores for a group of items. The UAP recommendation system 110 may be operative or configured to receive other types of requests based on a user's attribute preferences. Further details of processes performed by components of the UAP recommendation system 110 in accordance with one or more aspects of the present disclosure are described with reference to FIGS. 2-12.

FIG. 2 illustrates an example embodiment of the UAP recommendation system 110. In the illustrated example, the UAP recommendation system 110 includes an item ranking engine 202, an attribute mapping engine 204, and a UAP scoring model 206. In an example implementation, the item ranking engine 202 may operate to collect data for a given user 101 for a specified or predetermined event during an online shopping session where one or more items 210 that are available for purchase via a website may be displayed in a UI 118. Example specified events may include the user 101 viewing or clicking on an item 210, the user 101 adding an item 210 to an online shopping cart associated with the website, and the user 101 purchasing an item 210 via an online checkout of the shopping cart.

In some examples, the item ranking engine 202 may operate to collect user session data 114 for the online shopping session, which may include, for each specified event that occurs during the online shopping session, a session ID 212, a user ID 214, a timestamp 216, a type of user interaction 218 with an item 210 (e.g., viewed 218a, added to cart 218b, or purchased 218c), an item ID 220, and, in some examples, other information 222.

In some examples, the item ranking engine 202 may further operate to analyze the collected user session data 114 to determine a user interest score for an item 210 based on the user's activity (i.e., the type of user interaction 218) with the item 210. In one example, the item ranking engine 202 may be configured to categorize an item 210 the user 101 viewed, clicked on, or otherwise selected into a first category (e.g., a viewed category), categorize an item 210 the user 101 added to the shopping cart into a second category (e.g., an add to cart category), and categorize an item 210 purchased by the user 101 into a third category (e.g., a purchased category).

The item ranking engine 202 may further operate to assign a user interest score to each item 210 based on the user activity category. In one example, a viewed item 210 may be assigned a first score indicative of a first level of interest (e.g., 2 on a scale from 0-10). In another example, an added to cart item 210 may be assigned a second score indicative of a second level of interest (e.g., 5). For example, the second score may indicate a higher level of interest than the first score. In another example, a purchased item may be assigned a third score indicative of a third level of interest (e.g., 10). For example, the third score may indicate a highest level of interest.

In some examples, the item ranking engine 202 may further operate to apply a decay function to the user interest scores to model how the user's preferences may change over time. For example, the item ranking engine 202 may be configured to, on a periodic basis (e.g., daily), apply a decay function that adjusts the user interest score based on how long ago the user activity associated with the item 210 occurred. That is, a user interest score may decay differently based on a function of days of inactivity. According to one example, a decay function that may be applied as a multiplier to a user interest score by the item ranking engine 202 may be:

$$1 - \frac{n}{365} ,$$

n=the number of days since the user activity. Accordingly, the user interest score may decay less for a more frequently purchased item 210, and decay more for a less frequently purchased item 210.

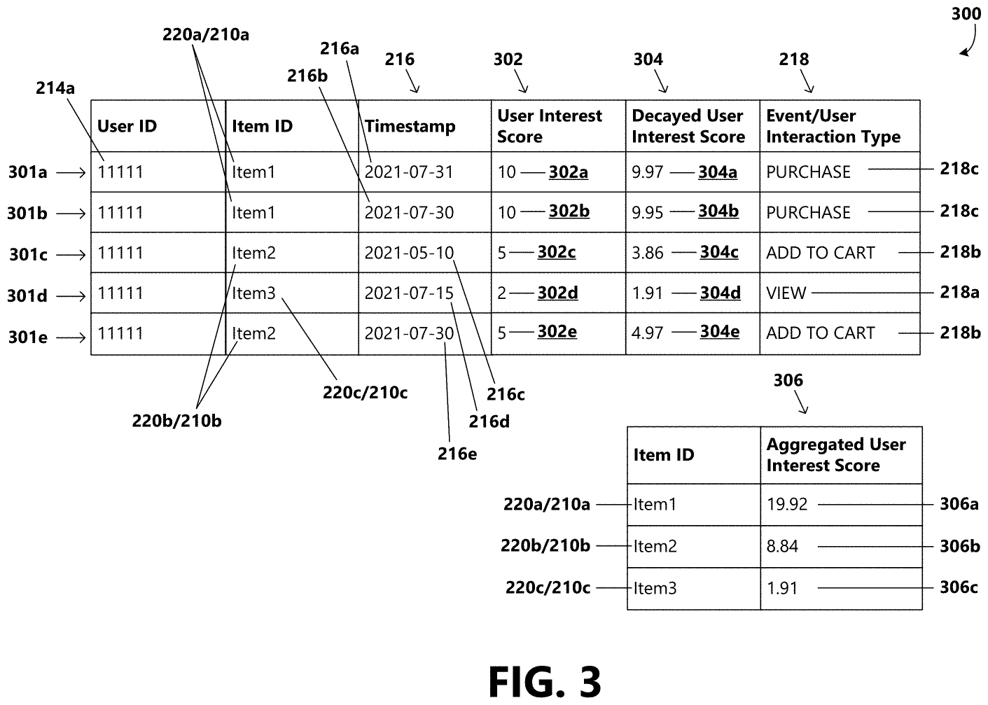

As an example, and with reference to FIG. 3, an example table 300 is shown that includes user session data 114 collected in association with detected events or user activities with various items 210a-c. As shown, the table 300 includes a plurality of data records 301a-e (generally, 301), wherein each data record 301 may be correspond with a particular user's user activity with an item 210a-c during an online shopping session. For example, the example user session data 114 shows that the user 101, identified by user ID 214a “11111,” purchased a first item 210a, as identified by item ID 220a “Item1” on 2021 Jul. 31, according to its timestamp 216a and the type of user interaction 218. Accordingly, the item ranking engine 202 may assign a first user interest score 302a of 10 to the first data record 301a. Consider, for example, the current date is 2021 Aug. 1. The item ranking engine 202 may apply the decay function to the first user interest score 302a, which may result in a first decayed user interest score 304b of 9.97, generally referred to herein as a decayed user interest score 304.

Continuing with the illustrated example, the collected user session data 114 further indicates that the user 101 purchased the same item (item1) 210a the previous day, as indicated by the timestamp 216b. Accordingly, the item ranking engine 202 may assign a second user interest score 302b of 10 to the second data record 301b based on the user interaction 218c, and further apply the decay function to the second user interest score 302b to adjust the second user interest score 302b based on a function of days of inactivity, which, in this example, is 2 days, resulting in a second decayed user interest score 304b of 9.95.

Continuing further with the illustrated example, the third data record 301c indicates that the user 101 may have added a second item (item2) 210b to the shopping cart on 2021 May 10, but did not purchase the second item 210b, as indicated by the timestamp 216c and the determined type of user interaction 218b. Accordingly, the item ranking engine 202 may assign a third user interest score 302c of 5 to the third data record 301c and further apply the decay function to the third user interest score 302c, resulting in a third decayed user interest score 304c of 3.86.

With reference still to FIG. 3, the fourth data record 301d indicates that the user 101 viewed a third item (item3) 210c on 2021 Jul. 15, as indicated by the timestamp 216d and the determined type of user interaction 218a. Accordingly, the item ranking engine 202 may assign a fourth user interest score 302d of 2 to the fourth data record 301d, and further apply the decay function to the fourth user interest score 302d, resulting in a fourth decayed user interest score 304d of 1.91.

Additionally, a fifth data record 301e indicates that the user 101 added the second item (item2) 210b to the shopping cart on 2021 Jul. 30, as indicated by the timestamp 216e and the determined type of user interaction 218b. Accordingly, the item ranking engine 202 may assign a fifth user interest score 302e of 5 to the third data record 301e and further apply the decay function to the fifth user interest score 302e, resulting in a fifth decayed user interest score 304e of 4.97.

In some examples, the item ranking engine 202 may further operate to aggregate user interest scores 302 for the user 101. For example and referring again to the example described in FIG. 3, the item ranking engine 202 may be configured to determine an aggregated user interest score 306 for various items 210. In some examples, the item ranking engine 202 may operate to aggregate user interest scores 302 for items 210 associated with an item type or category (e.g., yogurt items, ladies shirts, shower curtains, chairs, soaps). Continuing with the example from above, the aggregated user interest score 306a for the first item (item1) 210a may be 19.92, the aggregated user interest score 306b for the second item (item2) 210b may be 8.84, and the aggregated user interest score 306c for the third item (item3) 210c may be 1.91. For example, the aggregated user interest scores 306 may represent a determined level of interest that the user may have in the associated items 210a-c. For example, the aggregated user interest scores 306 indicate that the user 101 has a higher level of interest in the second item 210b than the third item 210c, and a higher level of interest in the first item 210a than the second item 210b. In some examples, the determined user interest scores 302, decayed user interest scores 304, and aggregated user interest scores 306 may be stored.

With reference again to FIG. 2, in some examples, the UAP recommendation system 110 may further operate to collect catalog data 112. For example, catalog data 112 may include, for an item 210, the item ID 214 that may identify the item 210, item classification information 226 (e.g., item category), item description information 228 (e.g., ingredients, benefits, use, instructions, images, ratings, reviews), item attribute information 230 (e.g., item brand, color, size, weight, flavor, organic, vegan, natural, clean, fair trade), and, in some examples, other information 232.

According to an example, the attribute mapping engine 204 may operate to obtain item classification information 226 about each item 210 identified in the collected user session data 114 to determine the item type or category of the items 210. According to an example, the attribute mapping engine 204 may further operate to obtain item attribute information 230 about each item 210 identified in the collected user session data 114 to map the determined aggregated user interest scores 306 to each item's attributes. In some examples, the attribute mapping engine 204 may use the item ID 220 included in the collected user session data 114 to map the item 210 to and to obtain catalog data 112 about the item 210.

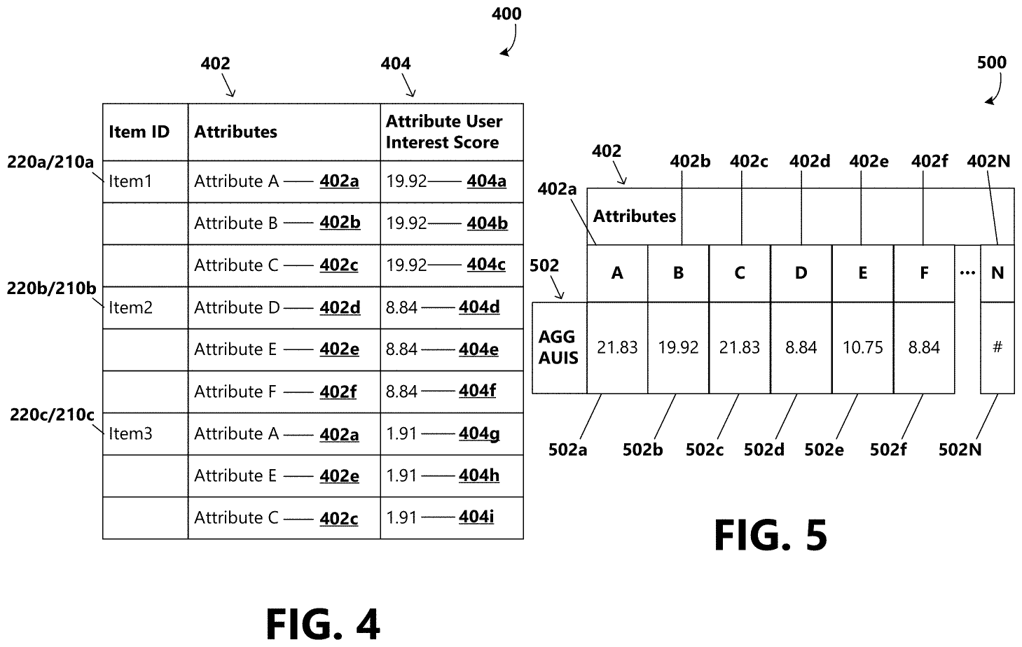

As an example, and with reference now to FIG. 4, an example table 400 is shown including a list of attributes 402a-e of item1, item2, and item3 210a-c. For example, the first item 210a, represented by item ID 220a “Item1,” may include a first attribute 402a: attribute A, a second attribute 402b: attribute B, and a third attribute 402c: attribute C. Although three attributes 402 are illustrated, in other examples, more or fewer attributes 402 may be associated with an item 210. For example, the attributes 402a-c may each describe a different aspect of the first item 210a, such as the item's brand, color, size, weight, flavor, whether the first item 210a is organic, vegan, natural, clean, fair trade, etc. Other types of attributes 402 are possible and are within the scope of the present disclosure. According to an example, item1, item2, and item3 210a-c may be associated with a same item category (e.g., based on item classification information 226).

Further as shown, the aggregated user interest score 306 associated with each item 210 may be mapped to each attribute 402 of the item 210. For example, the aggregated user interest score 306a for the first item (item1) 210a (e.g., 19.92) may be mapped to each of the first item's attributes 402a, 402b, and 402c. Accordingly, each attribute 402a, 402b, 402c associated with the first item (item1) 210a may be assigned a user interest score, herein referred to as an attribute user interest score 404. For example, for the first item 210a, attribute A 402a, attribute B 402b, and attribute C 402c each have an assigned attribute user interest score 404a, 404b, 404c of 19.92.

In the illustrated example, the second item 210b may have various attributes 402 (e.g., attribute D 402d, attribute E 402e, and attribute F 402f) associated with it. Like with the first item 210a, the attribute mapping engine 204 may operate to assign the aggregated user interest score 306b determined for the second item 210b (e.g., 8.84) to each of the second item's attributes 402d, 402e, 402f. Moreover, the third item 210c may have various attributes 402 (e.g., attribute A 402a, attribute E 402e, and attribute C 402c) associated with it. Like with the first and second items 210a,b, the attribute mapping engine 204 may further operate to assign the aggregated user interest score 306c determined for the third item 210c (e.g., 1.91) to each of the third item's attributes 402a, 402e, 402c. In some examples, the attribute mapping engine 204 may further operate to aggregate attribute user interest scores 404 across a particular attribute 402.

For example, and with reference now to FIG. 5, an example table 500 is shown including a list of all attributes 402a-n across items 210 for which user session data 114 has been collected and aggregated attribute user interest scores 502 determined for the attributes 402. According to one example, the list of attributes 402 and the aggregated attribute user interest scores 502 may correspond with an item type or item category. According to another example, the list of attributes 402 and the aggregated attribute user interest scores 502 may span a plurality of item types or categories. As shown, attribute A 402a may have an aggregated attribute user interest score 502a of 21.83, attribute B 402b may have an aggregated attribute user interest score 502b of 19.92, attribute C 402c may have an aggregated attribute user interest score 502c of 21.83, attribute D 402d may have an aggregated attribute user interest score 502d of 8.84, attribute E 402e may have an aggregated attribute user interest score 502e of 10.75, and attribute F 402f may have an aggregated attribute user interest score 502f of 8.84. According to an example aspect, the determined aggregated attribute user interest scores 502 may be stored in the datastore 106. As should be appreciated, the aggregated attribute user interest scores 502 may be adjusted cyclically, for example, based on the decay factor to accommodate the way in which the user's interests or preferences may change over time and new user session data 114 that may be received by the UAP recommendation system 110.

With reference again to FIG. 2, in some examples, the UAP recommendation system 110 may further operate to collect sales data 116 associated with online shopping sessions. For example, sales data 116 may include a data record comprising a transaction ID 224, item IDs 214 identifying one or more items 210 purchased, item prices 234 identifying the price of each item 210 purchased, a timestamp 236 of the purchase, the session ID 212 identifying the online shopping session, the user ID 214 associated with the user 101 making the purchase, and, in some examples, other information 238. In an example implementation, the UAP recommendation system 110 may be configured to use one or more application programming interfaces (APIs) to communicate with and obtain one or a combination of the user session data 114, the catalog data 112, and/or the sales data 116.

In an example implementation, the UAP scoring model 206 may operate to receive a request 244 for a UAP-based recommendation 240 and to determine and provide a UAP-based recommendation 240 in response. For example, the request 244 may be received from the web server 108, a recommendation engine 248, or another UAP-based recommendation requesting device 102. In some examples, the recommendation engine 248 may operate to initially generate item recommendations using convolutions on weighted graphs. Generally, this includes performing sampling, weighting, and aggregation processes for purposes of modeling relationships among items 210 to identify such item recommendations. In example implementations, weights in graphs (e.g., edge weights) may be used for sampling, aggregation as well as generation of random walks, and measuring loss. Accordingly, such a framework can be used to generate item recommendations for a retailer to present to the user 101, e.g., in an online retail environment. For example, the requested UAP-based recommendation 240 may be used to determine which of the item recommendations determined by the recommendation engine 248 to present to the user 101 for increasing the chances of the user 101 selecting and purchasing the item recommendation.

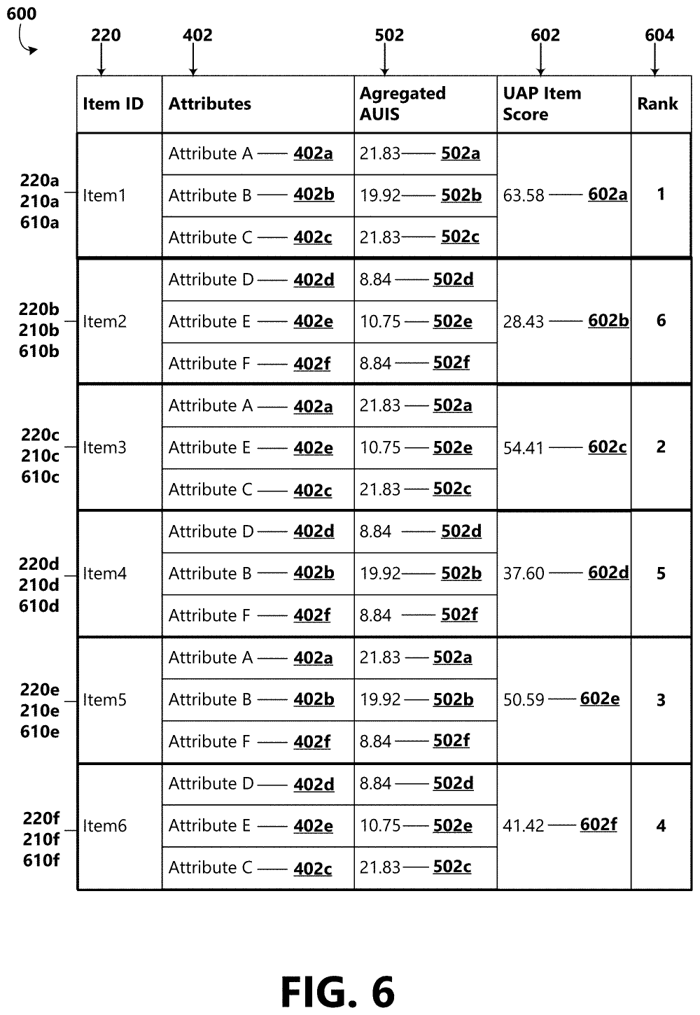

According to one example, the user 101 may initiate or rejoin an online shopping session by utilizing a user agent 242 (e.g., web browser, a web application, a mobile application) operating on the user computing device 120 to interface the web server 108 in the online shopping session. During the online shopping session, the user 101 may access a webpage in which one or more items 210 that are available for purchase via the online retailer website may be displayed in the user agent UI 118. In some examples, the web server 108 (or the recommendation engine 248 or another UAP-based recommendation requesting device) may be configured to request UAP-based recommendations 240 associated with one or more items 210 (referred to herein as items of interest 610, shown in FIG. 6). According one example, the items of interest 610 may include items 210 included in the webpage. The one or more items 210 displayed in the webpage, in some examples, may correspond to a group of items, such as an item category. In some examples, the web server 108 may be configured to request UAP-based recommendations 240 for items 210 associated with that item category, or in other examples, the UAP scoring model 206 may determine the item category associated with an item 210 that may be referenced in the request. In some examples, item classification information 226 included in the catalog data 112 may be utilized to identify an item's item category.

According to one example implementation, the UAP scoring model 206 may operate to determine items 210 associated with the request 244 and to determine user attribute preference (UAP) scores for the items of interest based on the aggregated attribute user interest scores 502 that were previously determined. For example, and with reference to FIG. 6, consider that the items of interest 610 determined for a request 244 include the first item (Item1) 210a,610a, the second item (Item2) 210b,610b, the third item (Item3) 210c,610c, a fourth item 210d,610d identified as Item4, a fifth item 210e,610e identified as Item5, and a sixth item 210f,610f identified as Item6.

According to an example, the UAP scoring model 206 may further operate to obtain item attribute information 230 about each item of interest 610 to map the determined aggregated attribute user interest scores 502 to each item of interest's attributes 402. For example, the UAP scoring model 206 may be configured to use the item IDs 220a-f associated with the items of interest 610a-f to obtain attribute information 230 about the items of interest 610a-f and to further obtain the determined aggregated attribute user interest scores 502a-f associated with each attribute 402a-f identified in the attribute information 230. As an example and as shown in FIG. 6, the first item of interest 610a may have attributes A, B, and C 402a-c, the second item of interest 610b may have attributes D, E, and F 402d-f, the third item of interest 610c may have attributes A, E, and C 402a,e,c, the fourth item of interest 610d may have attributes D, B, and F 402d,b,f, the fifth item of interest 610e may have attributes A, B, and F 402a,b,f, and the sixth item of interest 610f may have attributes D, E, and C 402d,e,c.

According to an example aspect, based on a summation of the determined aggregated attribute user interest scores 502a-f included in FIG. 5, a UAP item score 602 may be determined for each item of interest 610, and the items of interest 610 may be ranked 604 based on the determined UAP item scores 602. As shown in FIG. 6, the UAP scoring model 206 may determine that the first item of interest 610a has a UAP item score 602a of 63.58, the second item of interest 610b has a UAP item score 602b of 28.43, the third item of interest 610c has a UAP item score 602c of 54.41, the fourth item of interest 610d has a UAP item score 602d of 37.60, the fifth item of interest 610e has a UAP item score 602e of 50.59, and the sixth item of interest 610f has a UAP item score 602f of 41.42. In some examples, the UAP scoring model 206 may further operate to rank the items of interest 610a-f, for example, based on the determined UAP item scores 602a-f, the first item of interest 610a may be ranked first, the third item of interest 610c may be ranked second, the fifth item of interest 610e may be ranked third, the sixth item of interest 610f may be ranked fourth, the fourth item of interest 610d may be ranked fifth, and the second item of interest 610b may be ranked sixth.

In some examples, the UAP scoring model 206 may further operate to provide a response 246 to the received request 244, wherein the response 246 may include UAP-based recommendations 240 determined based on the UAP item scores 602 and rankings 604 determined for the identified items of interest 610. According to one example, the UAP-based recommendations 240 may include a top N items of interest 610, wherein N may represent a predetermined or configurable number or percent (e.g., top 5 ranked items of interest 610, top 100 ranked items of interest 610, top 1% of the ranked items of interest 610, top 10% of the ranked items of interest 610).

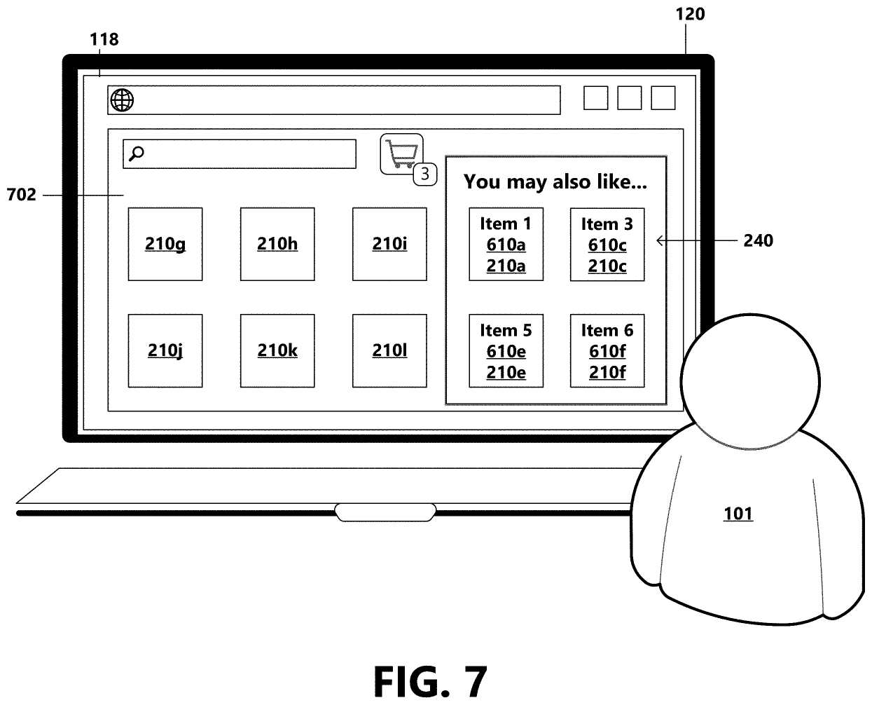

As an example and as illustrated in FIG. 7, the UAP scoring model 206 may generate a response 246 including the top 4 ranked items of interest 610 as the determined UAP-based recommendations 240, which, based on the determined UAP item scores 602 and the rankings 604, may include the first item of interest 610a (e.g., Item1 210a), the third item of interest 610c (e.g., Item3 210c), the fifth item of interest 610e (e.g., Item5 210e), and the sixth item of interest 610f (e.g., Item6 210f). Accordingly, and as illustrated, the UAP-based recommendations 240 may be presented to the user 101. For example, the UAP-based recommendations 240 may be presented in the user agent UI 118 that may include the webpage 702 comprising a group of items 210g-l available for purchase via the online retailer website. In some examples, the group of items 210g-l are related to an item category, such as an item type (e.g., yogurt, shirt, chair, soap), and the UAP-based recommendations 240 may also be associated with the same item category. For example, if the items 210g-l displayed on the webpage 702 include various brands or types of yogurt, the items 210a,c,e,f presented to the user 101 as UAP-based recommendations 240 may also be various brands or types of yogurt that include attributes that are determined to be preferential to the user 101. In some examples, the recommendations 240 may be presented to the user 101 in a UI 118 separate from the UI 118 including items 210g-l.

According to another example, the UAP scoring model 206 may operate to receive a request from a recommendation engine 248 to sort a list of items 210 based on UAP item scores 602. For example, the UAP scoring model 206 may determine UAP item scores 602 for each item 210 included in the list, rank the items 210 based on the determined UAP item scores 602, and provide a response 246 including the list of items 210 sorted according to the rankings 604.

According to another example, the UAP scoring model 206 may operate to receive a request 244 for UAP-based recommendations 240 that may include a request for a top N (e.g., 5, ⅔rds) ranked item categories for the user 101. For example, the UAP scoring model 206 may operate to determine a ranked list of item categories based on UAP item scores 602 determined for a set of items of interest 610. In one example, the set of items of interest 610 may include all items 210 offered for sale by the retailer, and the top N ranked item categories may include item categories having items 210 that include the attributes 402 preferred by the user 101. In response to the request 244, the UAP scoring model 206 may operate to provide, in a response 246, the top N ranked item categories.

According to another example, the UAP scoring model 206 may operate to receive a request 244 for UAP-based recommendations 240 that may include a request for a top N (e.g., 5, ⅔rds) ranked item brands for the user 101. For example, the UAP scoring model 206 may operate to determine a ranked list of item brands based on UAP item scores 602 determined for a set of items of interest 610. In one example, the set of items of interest 610 may include all items 210 offered for sale by the retailer, and the top N ranked item brands may include item brands associated with items 210 that include the attributes 402 preferred by the user 101. In response to the request 244, the UAP scoring model 206 may operate to provide, in a response 246, the top N ranked item brands.

According to another example, the UAP scoring model 206 may operate to receive a request 244 for UAP-based recommendations 240 that may include a request for a top N ranked items 210 for the user 101 based on a ranked list of item categories and/or brands. For example, the UAP scoring model 206 may operate to determine a set of top ranked items 210 associated with the determined top N ranked item categories and/or brands. In response to the request 244, the UAP scoring model 206 may operate to provide, in a response 246, the top N ranked items 210.

According to another example, the UAP scoring model 206 may operate to receive a request for UAP-based recommendations 240 that may include a request for UAP item scores 602 for a set of items of interest 610. In response to the request 244, the UAP scoring model 206 may operate to provide, in a response 246, the UAP item scores 602 for the set of items of interest 610.

In other examples, the UAP recommendation system 110 may further operate to receive requests 244 for and provide responses 246 related to other types of UAP-based recommendations 240.

As should be appreciated, aspects of the UAP recommendation system 110 may provide various advantages. One example advantage includes allowing recommendations to be generated for new items 210 (i.e., items the user 101 may not have had a previous interaction with) based on the user's preference for one or more attributes 402 of the new items 210. For example, a measurement of the user's preference may be based on the type of interaction the user 101 had (in previous online shopping sessions) with other items 210 that have one or more attributes 402 in common with a new item 210. For example, a measurement of preference may be based on whether the user 101 viewed, purchased, or added the other items 210 to the online shopping cart. In some examples, the measurement of the user's preference may be further based on the amount of time since the interaction the user 101 had with the other items 210 in previous online shopping sessions.

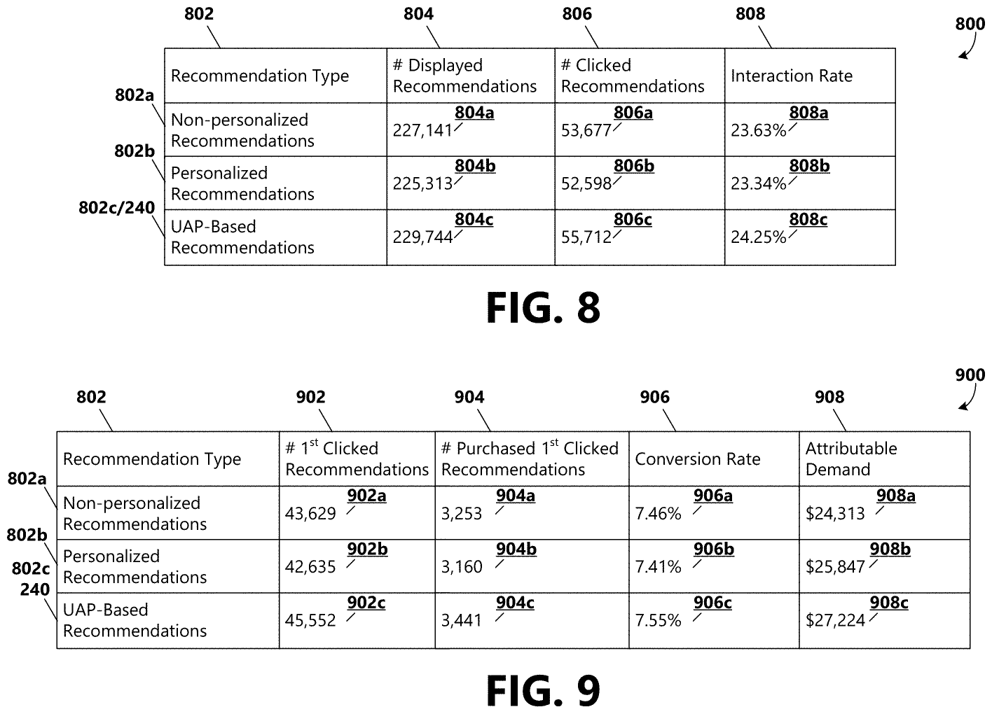

According to another example advantage and with reference now to FIG. 8, a table 800 is illustrated that includes results of a comparison between users' interactions with non-personalized recommendations 802a, personalized recommendations 802b, and UAP-based recommendations 802c,240 presented to a plurality of users 101. In the table 800 shown, an interaction with a recommendation 802 may include a selection of the recommendation 802, which, in some examples, may comprise clicking on the recommendation 802. In some examples, a non-personalized recommendation 802a may include a recommendation based on popularity of the item (e.g., best-selling items), based on similarities between an item being viewed, items that are frequently purchased together, etc. In some examples, a personalized recommendation 802b may include a recommendation based on input about the user's interests, such as the fact that the item was previously purchased by the user 101 or based on other items previously purchased by the user. Other types of non-personalized and personalized recommendations 802a,b are possible and are within the scope of the present disclosure.

As shown, results of the comparison indicate that users 101 had a higher interaction rate 808c with UAP-based recommendations 802c,240 than with non-personalized recommendations 802a or personalized recommendations 802b by several percent. For example, of 229,744 displayed 804c UAP-based recommendations 802c, 240 users 101 selected/clicked on 806c 55,712, resulting in an interaction rate 808c of 24.25%, while of 227,141 displayed 804a non-personalized recommendations 802a, users 101 selected/clicked on 806a 53,677, resulting in an interaction rate 808a of 23.63%, and of 225,313 displayed 804b personalized recommendations 802b, users 101 selected/clicked on 806b 52,598, resulting in an interaction rate 808b of 23.34%. As should be appreciated, when a user 101 selects/clicks on a recommended item (i.e., recommendation 802), the chances of the user 101 purchasing the recommended item may be increased. Accordingly, by increasing the interaction rate 808c using UAP-based recommendations 802c,240, conversions of the selections/clicks to purchases of the recommended items 802 may be increased.

According to another example advantage and with reference now to FIG. 9, another table 900 is illustrated that includes results of a comparison between conversion rates 906 of selections/clicks 902 of recommendations 802 to purchases 904 of the recommended items based on the recommendation type. For example, as shown, results of the comparison indicate that a higher conversion rate 906c was experienced with UAP-based recommendations 802c,240 than with non-personalized recommendations 802a or personalized recommendations 802b. For example, of 45,552 items 210 presented to users 101 as UAP-based recommendations 802c and that were subsequently selected/clicked on 902c, the users 101 purchased 904c 3,441 of those items 210, resulting in a conversion rate 906c of 7.55% and an attributable demand 908c of $27,224, while of 43,629 items 210 presented to users 101 as non-personalized recommendations 802a and that were subsequently selected/clicked on 902a, the users 101 purchased 904a 3,253 of those items 210, resulting in a conversion rate 906a of 7.46% and an attributable demand 908a of $24,313 and of 42,635 items 210 presented to users 101 as personalized recommendations 802b and that were subsequently selected/clicked on 902b, the users 101 purchased 904b 3,160 of those items 210, resulting in a conversion rate 906b of 7.41% and an attributable demand 908b of $25,847. Accordingly, as shown in FIG. 9, the comparison indicates an improved attributable demand 908 of items 210 presented to users 101 as UAP-based recommendations 802c,240 than as non-personalized recommendations 802a or personalized recommendations 802b, which may further result in increased revenue for the retail enterprise.

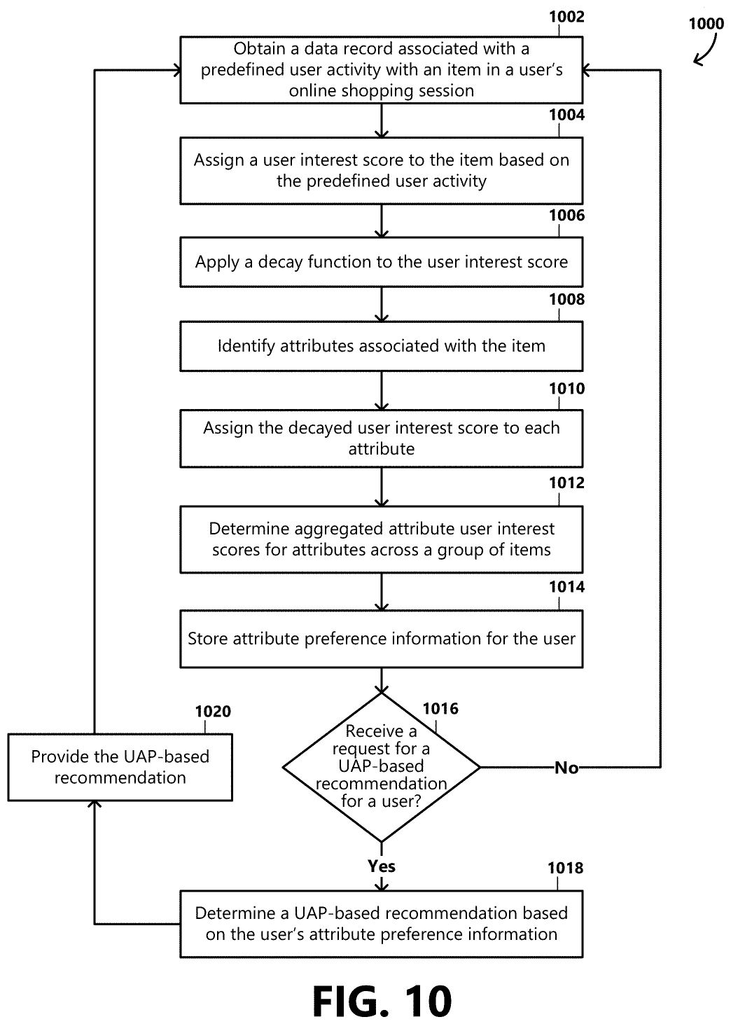

In FIG. 10, a flow chart is shown depicting general stages of an example process or method 1000 for providing a UAP-based recommendation 240,802c according to an embodiment. At OPERATION 1002, a data record 301 associated with a user's 101 online shopping session with a retail enterprise may be received by the UAP recommendation system 110. For example, the user 101 may operate a user computing device 120 to communicate with the retail enterprise's web server 108 to engage in the online shopping session. According to an example, the data record 301 may include user session data 114 corresponding to a predefined user activity performed in association with a first item 210 during the online shopping session. For example, the user session data 114 may include information about a viewing event (e.g., selecting or clicking on the first item 210), adding the first item 210 to the shopping cart, or purchasing the first item 210. In some examples, the UAP recommendation system 110 may operate to subscribe to receive user session data 114 related to the particular type of user interaction 218. In some implementations, the UAP recommendation system 110 may operate to receive and process a batch of data records 301, for example, data records 301 for a period of time (e.g., a day, a portion of a day, multiple days).

At OPERATION 1004, a user interest score 302 may be assigned to the first item 210 based on the predefined user activity. For example, the UAP recommendation system 110 may be operative or configured to assign a first user interest score 302 to items 210 that have been viewed, a second user interest score 302 to items 210 that have been added to the online shopping cart, and a third score 302 to items 210 that have been purchased. According to an example, the first user interest score 302 may have a value indicative of a first level of interest, the second user interest score 302 may have a value indicative of a second level of interest, wherein the second level of interest may be higher than the first level, and the third user interest score 302 may have a value indicative of a third level of interest, wherein the third level of interest may be the highest level of interest.

At OPERATION 1006, a decay function, configured to adjust the user interest score 302 based on how long ago the user activity associated with the first item 210 occurred, may be applied to the user interest score 302. According to one example, the decay function may be applied as a multiplier

$$( e . g . , 1 - \frac{n}{365} )$$

to the user interest score 302, resulting in a decayed user interest score 304 that may decrease based on n (e.g., the number of days since the occurrence of the predefined user activity).

At OPERATION 1008, attributes 402 associated with the first item 210 may be identified. For example, information about the item's attributes 402 may be included in catalog data 112 that may be obtained or otherwise accessed by the UAP recommendation system 110.

At OPERATION 1010, the decayed user interest score 304 may be assigned to each attribute 402 associated with the first item 210. For example, if the first item 210 has 5 attributes 402 associated with it, each of the 5 attributes 402 may be assigned the decayed user interest score 304 determined for the first item 210.

At OPERATION 1012, decayed user interest scores 304 assigned to an attribute 402 may be aggregated across a group of items 210. For example, the first of the 5 attributes 402 may be associated with a plurality of items 210 included in the group, and the decayed user interest scores 304 assigned to the first attribute 402 across the plurality of items 210 may be aggregated into a combined aggregated attribute user interest score 502.

In some examples, the group may include items 210 that the user 101 has interacted with according to a predefined user activity in one or more previous online shopping sessions and for which user session data 114 corresponding to the predefined user activity may be accessed. According to an example, the group may include items 210 associated with the same item category as the first item 210. According to another example, the group may include items 210 related to the first item's item category. According to another example, the group may be agnostic of an item category. Other types of groups are possible and are within the scope of the present disclosure.

At OPERATION 1014, the determined aggregated attribute user interest scores 502 and other attribute preference information may be stored in association with the user 101.

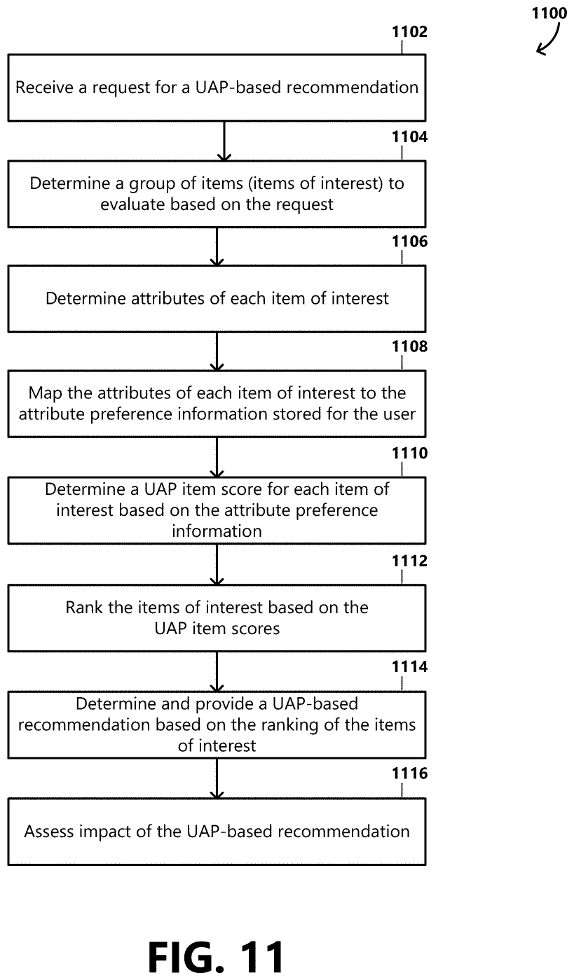

At DECISION OPERATION 1016, a determination may be made as to whether a request 224 from a UAP-based recommendation requesting device 102 for a UAP-based recommendation 240 related to a user 101 may be received. For example, the UAP-based recommendation requesting device 102 may include the web server 108 associated with the retail enterprise, a recommendation engine 248, or another UAP-based recommendation requesting device 102. When a request 224 is not received, the method 1000 may return to OPERATION 1002 to process a next data record 301. When a request 224 is received, the method 1000 may proceed to OPERATION 1018, where a UAP-based recommendation 240 may be determined for the user 101. General stages of an example process or method for determining a UAP-based recommendation 240 are described below with reference to FIG. 11.

At OPERATION 1020, the determined UAP-based recommendation 240 may be provided to the UAP-based recommendation requesting device 102, and the method 1000 may return to OPERATION 1002 to process a next data record 301.

With reference now to FIG. 11, a flow chart is shown depicting general stages of an example process or method 1100 for providing a UAP-based recommendation 240 according to an embodiment. At OPERATION 1102, a request 244 may be received from a UAP-based recommendation requesting device 102 for a UAP-based recommendation 240 related to a user 101. For example, the user 101 may operate a user computing device 120 to communicate with the retail enterprise's web server 108 to engage in an online shopping session, and the request 244 may be related to identifying items 210 to present to the user 101 as a recommendation 802. According to an example, the request 244 may indicate an item category for the requested UAP-based recommendation 240. In one example, the item category may be or may be related to an item category requested by the user 101, such as part of a search for an item 210 or the item category, the user 101 viewing an item 210 associated with the item category, or another event.

At OPERATION 1104, a set of items 210 may be determined as items of interest 610 based on the request 244 that may be evaluated for determining the UAP-based recommendation 240. In one example, the items of interest 610 may include items 240 associated with the item category.

At OPERATION 1106, attributes 402 associated with each item of interest 610 may be determined. In one example, item attributes information 230 may be utilized to identify an item of interest's attributes 402.

At OPERATION 1108, the attributes 402 determined for each item of interest 610 may be mapped to attribute preference information stored for the user 101. For example, the attribute preference information may include the aggregated attribute user interest scores 502 and other attribute preference information determined and stored using the example method 1000 described above with reference to FIG. 10.

At OPERATION 1110, a UAP item score 602 may be determined for each item of interest 610 based on the attribute preference information mapped to each item of interest's attributes 402. For example, the aggregated attribute user interest score 502 for each attribute 402 associated with an item of interest 610 may be aggregated, resulting in the UAP item scores 602.

At OPERATION 1112, the items of interest 602 may be ranked based on the UAP item scores 602, and at OPERATION 1114, a UAP-based recommendation 240 may be determined and provided based on the rankings 604. For example, the UAP-based recommendation 240 may include a top N (e.g., configurable number or percent) ranked items of interest 610, a top N ranked item categories or item brands for the user 101, a sorted list of items of interest 610, UAP item scores 602 for a list of items of interest 610, or another UAP-based recommendation 240. For example, one or more items 210 included in the UAP-based recommendation 240 may be presented as a recommendation 802 to the user 101. According to one example, the UAP-based recommendation 240 may be presented in a UI 118 associated with the website hosted by the retail enterprise's web server 108 in which the user 101 may be engaged in the online shopping session.

At OPERATION 1116, impact of the UAP-based recommendation 240 may be assessed. This may include, for example, determining a rate of selection of items 240 recommended as UAP-based recommendations 240 and a rate of conversion to purchases of UAP-based recommended items 240. Such a rate of selection or conversion may be used to tune the parameters used by the UAP recommendation system 110 to determine UAP-based recommendations 240 as described herein, for example, to improve performance, or to compare to other item recommendation 802 approaches, such as shown in FIGS. 8 and 9.

FIG. 12 illustrates an example computing system 1200 with which aspects of the present disclosure may be implemented. In an example, one or more components of the UAP recommendation system 110 can be implemented as one or more systems 1200 or one or more systems having one or more components of systems 1200. In an example, the system 1200 can include a computing environment 1210. The computing environment 1210 can be a physical computing environment, a virtualized computing environment, or a combination thereof. The computing environment 1210 can include memory 1220, a communication medium 1238, one or more processing units 1240, a network interface 1250, and an external component interface 1260.

The memory 1220 can include a computer readable storage medium. The computer storage medium can be a device or article of manufacture that stores data and/or computer-executable instructions. The memory 1220 can include volatile and nonvolatile, transitory and non-transitory, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data.

The memory 1220 can store various types of data and software. For example, as illustrated, the memory 1220 includes instructions 1222 for implementing one or more processes described herein (e.g., as described in relation to FIGS. 1-11), database 1230, as well as other data 1232. In some examples (e.g., where the computing environment 1210 is the UAP recommendation system 110), the memory 1220 can include instructions for: determining and storing attribute preference information for a user 101, receiving a request 244 for a UAP-based recommendation 240 for the user 101, determining a UAP-based recommendation 240 based on the stored attribute preference information, and providing the UAP-based recommendation 240 in a response 246.

The communication medium 1238 can facilitate communication among the components of the computing environment 1210. In an example, the communication medium 1238 can facilitate communication among the memory 1220, the one or more processing units 1240, the network interface 1250, and the external component interface 1260. The communication medium 1238 can be implemented in a variety of ways, including but not limited to a PCI bus, a PCI express bus accelerated graphics port (AGP) bus, a serial Advanced Technology Attachment (ATA) interconnect, a parallel ATA interconnect, a Fiber Channel interconnect, a USB bus, a Small Computing system interface (SCSI) interface, or another type of communication medium.

The one or more processing units 1240 can include physical or virtual units that selectively execute software instructions. In an example, the one or more processing units 1240 can be physical products comprising one or more integrated circuits. The one or more processing units 1240 can be implemented as one or more processing cores. In another example, one or more processing units 1240 are implemented as one or more separate microprocessors. In yet another example embodiment, the one or more processing units 1240 can include an application-specific integrated circuit (ASIC) that provides specific functionality. In yet another example, the one or more processing units 1240 provide specific functionality by using an ASIC and by executing computer-executable instructions.

The network interface 1250 enables the computing environment 1210 to send and receive data from a communication network 104. The network interface 1250 can be implemented as an Ethernet interface, a token-ring network interface, a fiber optic network interface, a wireless network interface (e.g., WI-FI), or another type of network interface.

The external component interface 1260 enables the computing environment 1210 to communicate with external devices. For example, the external component interface 1260 can be a USB interface, Thunderbolt interface, a Lightning interface, a serial port interface, a parallel port interface, a PS/2 interface, and/or another type of interface that enables the computing environment 1210 to communicate with external devices. In various embodiments, the external component interface 1260 enables the computing environment 1210 to communicate with various external components, such as external storage devices, input devices, speakers, modems, media player docks, other computing devices, scanners, digital cameras, and fingerprint readers.

Although illustrated as being components of a single computing environment 1410, the components of the computing environment 1410 can be spread across multiple computing environments 1410. For example, one or more of instructions or data stored on the memory 1420 may be stored partially or entirely in a separate computing environment 1410 that is accessed over a network 104.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., portions, components, etc.) described with respect to the figures herein are not intended to limit the systems and methods to the particular aspects described. Accordingly, additional configurations can be used to practice the methods and systems herein and/or some aspects described can be excluded without departing from the methods and systems disclosed herein.

Similarly, where steps of a process are disclosed, those steps are described for purposes of illustrating the present methods and systems and are not intended to limit the disclosure to a particular sequence of steps. For example, the steps can be performed in differing order, two or more steps can be performed concurrently, additional steps can be performed, and disclosed steps can be excluded without departing from the present disclosure.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

We claim:

1. A system for providing item recommendations based on a user's attribute preferences, comprising:
at least one processor; and
a memory coupled to the at least one processor, the memory including instructions that when executed by the at least one processor cause the system to:
receive a request for an item recommendation for a user, the item recommendation corresponding to items available for purchase from a retail website;
determine a set of items of interest to evaluate based on the request;
identify attributes associated with each item of interest;
map the one or more attributes to attribute preference information stored for the user, the attribute preference information including a first score corresponding to each attribute, the first score determined based on a type of an interaction and an amount of time since the interaction performed by the user in one or more online shopping sessions with one or more of the items available for purchase;
determine a second score for each item of interest based on the attribute preference information;
rank the items of interest based on the second scores;
determine a UAP-based recommendation based on the ranked items of interest; and
generate a response to the request including the UAP-based recommendation to be presented to the user in a user interface, the UAP-based recommendation including one or more items having attributes preferred by the user.

2. The system of claim 1, wherein, the first score corresponding to each attribute includes an aggregation of one or more third scores determined for one or more items interacted with by the user and that include the attribute.

3. The system of claim 2, wherein the one or more third scores are determined based on a type of interaction performed by the user with the one or more items that include the attribute.

4. The system of claim 3, wherein the type of interaction comprises at least one of:
an item selection;
an addition of an item to a shopping cart; or
an item purchase.

5. The system of claim 3, wherein the one or more third scores comprise an aggregation of fourth scores, wherein:
each fourth score corresponds to an interaction with the associated item;
each fourth score has a value corresponding to the type of interaction; and
each fourth score includes a decay function that adjusts the fourth score based on a number of days since the interaction.

6. The system of claim 5, wherein the decay function is:
$$1 - \frac{n}{365} ,$$
wherein: n=the number of days since the user activity.

7. The system of claim 5, wherein:
the first score is an aggregated attribute user interest score;
the second score is a UAP item score;
the third score is:
an aggregated user interest score applied to the item; or
an attribute user interest score applied to each attribute of the item;
the fourth score is a decayed user interest score.

8. The system of claim 1, wherein the set of items of interest to evaluate is determined based on an item category.

9. The system of claim 1, wherein the UAP-based recommendation includes one of:
a top number or percent of ranked items of interest;
a top number or percent of ranked item categories;
a top number or percent of ranked item brands;
a list of the items of interest and their associated second score; and
a list of the items of interest sorted by rank.

10. A method of providing item recommendations based on a user's attribute preferences comprising:
receiving a request for an item recommendation for a user, the item recommendation corresponding to items available for purchase from a retail website;
determining a set of items of interest to evaluate based on the request;
identifying attributes associated with each item of interest;
mapping the one or more attributes to attribute preference information stored for the user, the attribute preference information including a first score corresponding to each attribute, the first score determined based on a type of an interaction and an amount of time since the interaction performed by the user in one or more online shopping sessions with one or more of the items available for purchase;
determining a second score for each item of interest based on the attribute preference information;
ranking the items of interest based on the second scores;
determining a user attribute preference (UAP)-based recommendation based on the ranked items of interest; and
generating a response to the request including the UAP-based recommendation to be presented to the user in a user interface, the UAP-based recommendation including one or more items having attributes preferred by the user.

11. The method of claim 9, wherein determining the first score comprises, for each attribute, aggregating one or more third scores determined for one or more items interacted with by the user and that include the attribute.

12. The method of claim 10, wherein determining the one or more third scores comprises:
assigning one or more fourth scores to each item based on a type of interaction performed by the user with the item;
applying a decay function to the one or more fourth scores to adjust the one or more fourth score based on a number of days since the interaction;
aggregating the one or more fourth scores; and
assigning the one or more fourth scores to each attribute associated with the item.

13. The method of claim 11, wherein assigning one or more fourth scores to each item based on the type of interaction performed by the user comprises at least one of:
assigning a first value as the fourth score when the interaction is an item selection;
assigning a second value as the fourth score when the interaction is adding an item to a shopping cart; and
assigning a third value as the fourth score when the interaction is an item purchase.

14. The method of claim 9, wherein determining the UAP-based recommendation includes one of:
determining a top number or percent of ranked items of interest;
determining a top number or percent of ranked item categories;
determining a top number or percent of ranked item brands;
determining a list of the items of interest and their associated second score; and
determining a list of the items of interest sorted by rank.

15. A computer readable storage device that includes executable instructions which, when executed by a processor, cause the processor to provide item recommendations based on a user's attribute preferences, the instructions comprising:
receiving a data record associated with an interaction performed by a user in association with an item available for purchase from a retail website;
assigning a user interest score to the item based on a type of interaction performed by the user;
applying a decay function to the user interest score to adjust the user interest score based on a number of days since the interaction;
identifying attributes associated with the item;
assigning the decayed user interest score to each of the attributes identified in association with the item;
determining an aggregated attribute user interest score for each attribute by aggregating the decayed user interest score assigned to the attribute; and
storing the aggregated attribute user interest scores.

16. The computer readable storage device of claim 15, the instructions further comprising:
receiving a request for an item recommendation for the user, the item recommendation corresponding to items available for purchase from the retail website;
determining a set of items of interest to evaluate based on the request;
identifying attributes associated with each item of interest;
mapping the one or more attributes to the aggregated attribute user interest scores determined for each attribute;
determining a user attribute preference (UAP) item score for each item of interest based on an aggregation of the aggregated attribute user interest scores;
ranking the items of interest based on the UAP item scores;
determining a UAP-based recommendation based on the ranked items of interest; and
generating a response to the request including the UAP-based recommendation to be presented to the user in a user interface, the UAP-based recommendation including one or more items having attributes preferred by the user.

17. The computer readable storage device of claim 16, wherein determining the set of items of interest to evaluate comprises evaluating items associated with an item category.

18. The computer readable storage device of claim 16, wherein determining the UAP-based recommendation includes one of:
determining a top number or percent of ranked items of interest;
determining a top number or percent of ranked item categories;
determining a top number or percent of ranked item brands;
determining a list of the items of interest and their associated UAP item score; and
determining a list of the items of interest sorted by rank.

19. The computer readable storage device of claim 15, wherein assigning the user interest score to the item based on the type of interaction performed by the user comprises one of:
assigning a first value as the user interest score when the interaction is an item selection;
assigning a second value as the user interest score when the interaction is adding an item to a shopping cart; and
assigning a third value as the user interest score when the interaction is an item purchase.

20. The computer readable storage device of claim 19, wherein determining the aggregated attribute user interest score for each attribute further comprises assigning one or more user interest scores to the item corresponding to one or more interactions performed by the user in association with the item.
